(19) United States
(12) Patent Application Publication
(10) Pub. No.: US 2017/0327314 A1
(43) Pub. Date: Nov. 16, 2017

(54) Carrier Tool With Self Adjusting Gripping and Prying Action

(71) Applicant: Daniel Thomas Germata, Waukegan, IL (US)

(72) Inventor: Daniel Thomas Germata, Waukegan, IL (US)

(73) Assignee: Formed From Function LLC., Waukegan, IL (US)

(21) Appl. No.: 15/597,146

(22) Filed: May 16, 2017

Related U.S. Application Data
(60) Provisional application No. 62/337,219, filed on May 16, 2016.

(51) Int. Cl. B65G 7/12

(52) U.S. Cl. CPC B65G 7/12

(57) ABSTRACT

The present invention is a self adjusting carrier tool that allows for the gripping, lifting, and carrying of objects. The tool is able to lift a large range of object widths without requiring large changes in tool height during operation. It accomplishes this through tongs retained by sliding friction-lock pivots acting against locking arms pivotally attached to opposing tongs. When the handle is lifted the action of these pivots allow the tongs to sweep a constant and effective angle against the the lifted object throughout the working range of the tool. At the limit of tong rotation the sliding friction-lock pivots engage and prevent any further movement of the tongs. Further lifting of the tool by the handle will then result in lifting of the tool and object together. The object will remain secured by the carrier tool until it is unloaded and the floating friction locks disengage.

### TECHNICAL FIELD

The present invention relates to the field of carrying tools. In addition this device relates to gripping, lifting, and prying tools.

### BACKGROUND ART

Conventional self adjusting lifting devices generally have a small grip width range relative to the overall working height of the tool. If the same tool is wished to be used to grip and lift an object of width X as well as an object of width 2X, it would typically require a change in height larger than X to actuate effective clamping and lifting action. Conventional gripping and lifting tools are typically ineffective for prying objects. Conventional prying tools are typically ineffective for lifting and carrying objects.

### SUMMARY OF THE INVENTION

The present invention is a self adjusting device that allows for the gripping, lifting, and carrying of objects while providing a prying action to the lifted object to aid initial movement against its surroundings.

The disclosed device (now called carrier cool) is able to lift a large range of object widths without requiring a large change in tool height for operation. It accomplishes this through tongs retained by sliding friction-lock pivots acting against locking arms. The action of these sliding pivots allow the tongs to sweep a constant and effective rotational angle against the contact point of the lifted object throughout the working width range of the tool. Initial lifting of the handle is translated to rotation of the tongs relative to the lifted object to provide for, engagement, clamping force, and significant mechanical advantage through prying action against the objects surroundings. At the limit of tong rotation the sliding friction lock pivots engage and prevent any further movement of the tongs relative to the lifted object. Further lifting of the tool by the handle will then result in lifting of the object. The object will remain secured by the carrier tool until it is unloaded and the floating friction locks disengage.

### BRIEF DESCRIPTION OF THE DRAWINGS

FIGS. 1 and 2 are front views of a preferred embodiment of the carrier tool gripped on a small and large object respectively;

FIGS. 3 and 4 are front views of a preferred embodiment of the carrier tool placed on a small and large object respectively;

FIG. 5 is a perspective view of the carrier tool gripped on a small object;

FIGS. 6, 7, and 8 are partially transparent views of the Sliding Friction-lock Pivot in various positions of operation.

FIGS. 9 and 10 show alternative construction of the sliding friction-lock pivots and alternative tong design.

FIG. 11 shows a front view of the carrier tool lifting a round object.

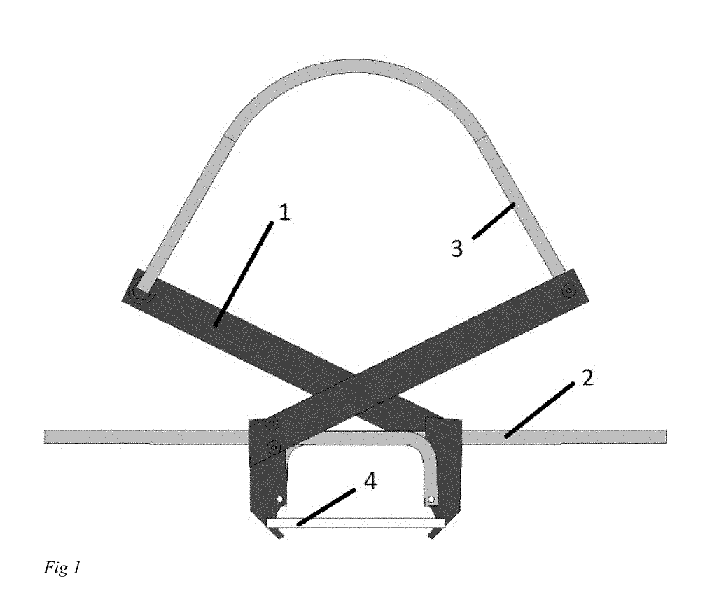

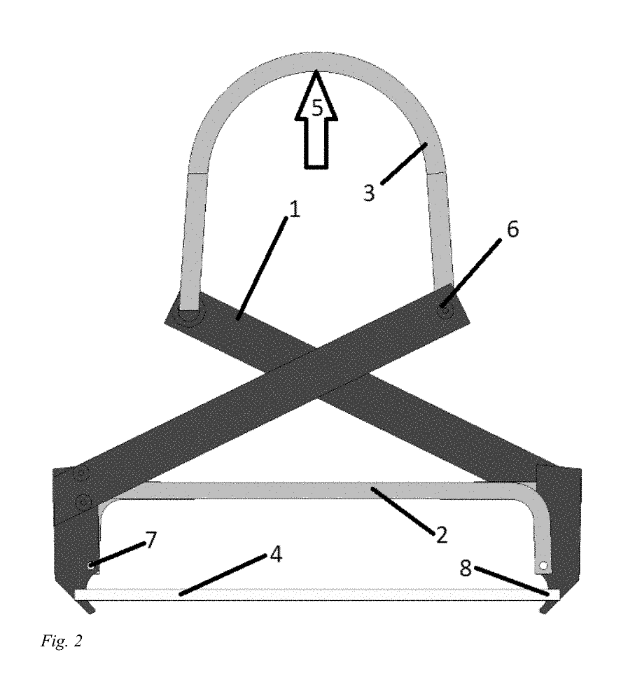

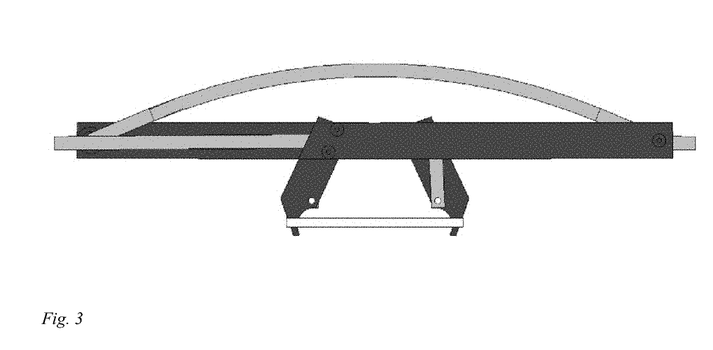

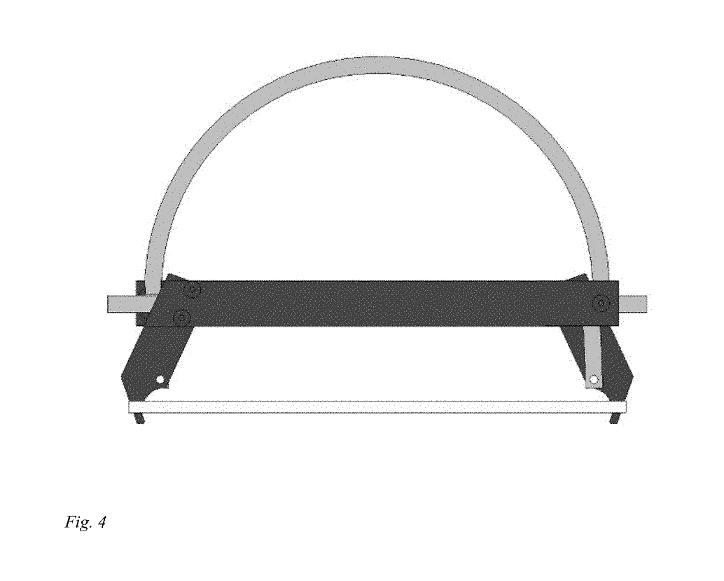

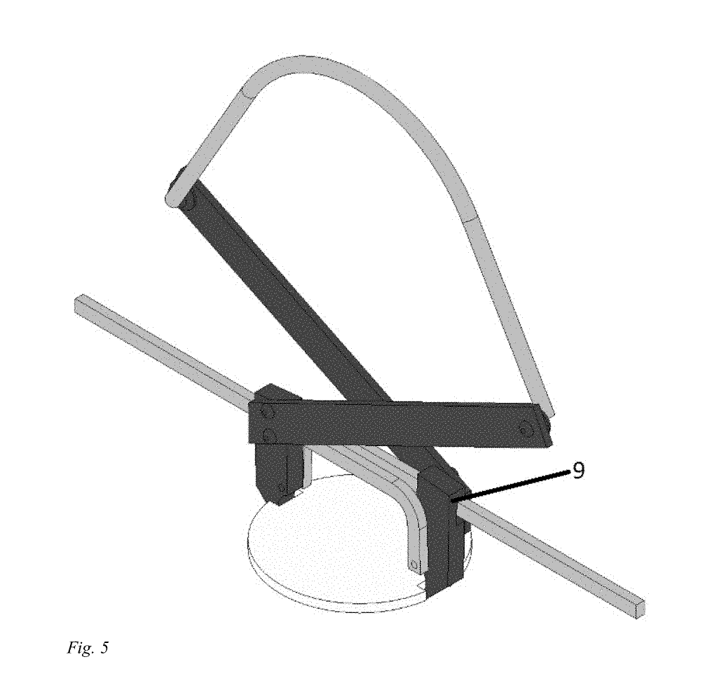

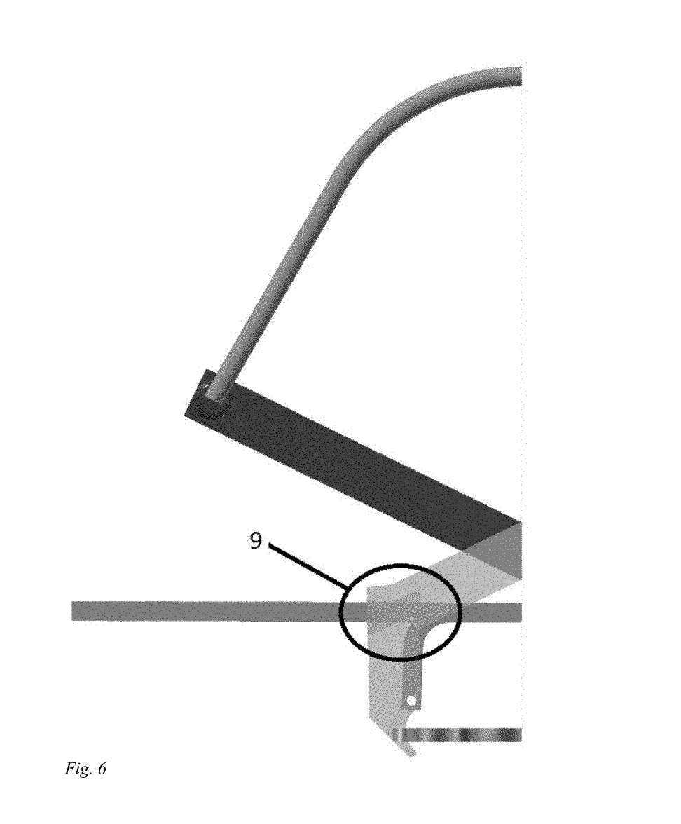

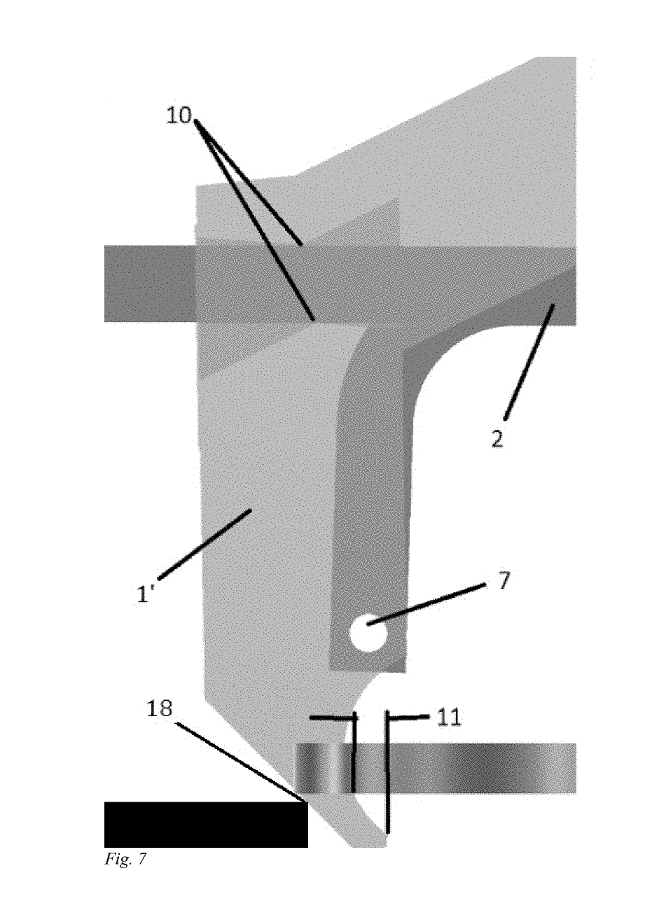

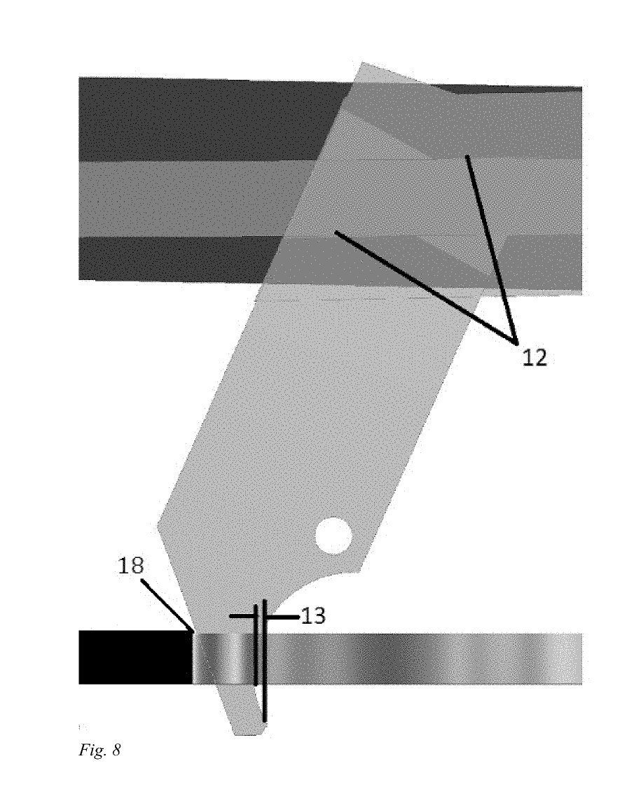

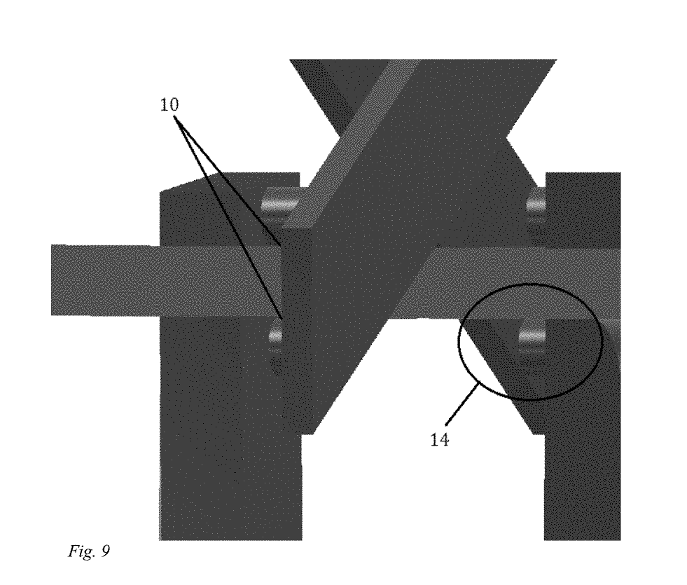

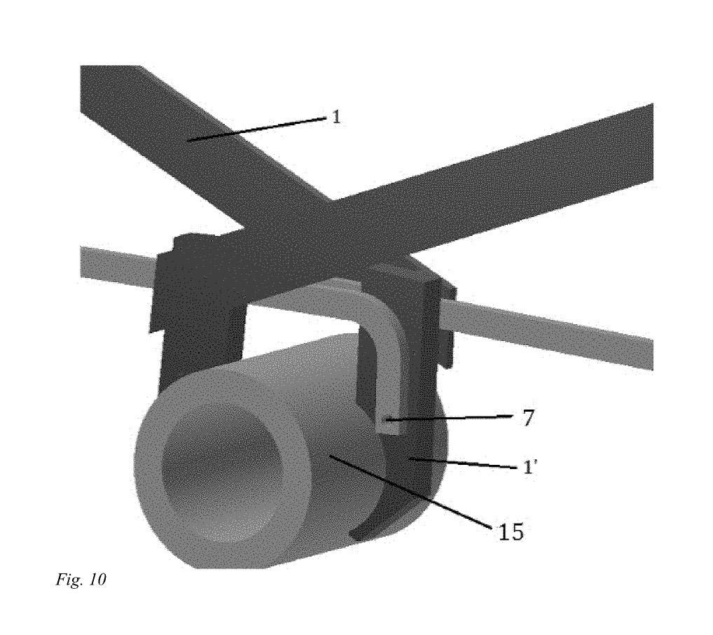

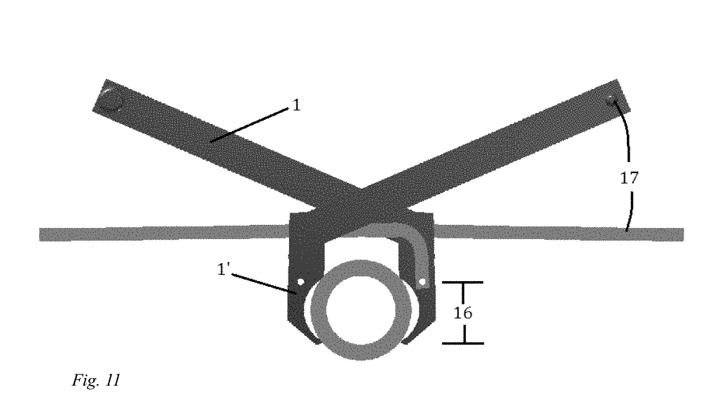

### DETAILED DESCRIPTION OF THE INVENTION

The disclosed carrier tool is designed to self adjust to lifted objects 4, 15 of multiple sizes. Adjustment is accomplished through means of linear actuation such that the tong tips 1′ of the tool are held in contact against the object to be lifted. One embodiment of the tool accomplishes this by spring action of the handle 3, it is designed out of a material such that its unloaded shape is along the horizontal plane of the tool but is constrained by the tongs 1 and sprung into an arch. The handle 3 material may be flat spring steel, steel cable, polymeric or a combination of the three. It is sized such that the elastic bending range accommodates all rated lifted object 4, 15 sizes. The initial clamping force applied by the sprung handle 3 or other actuation allows the carrier tool to be retained by the lifted object 4, 15 and to cause rotation of the tongs 1 and tong tips 1′ vs complete withdraw of the tool upon initial lifting force 5 applied to the handle 3. The handle 3 may be attached to the tongs 1 via Pivots 6.

The tong tips 1′ of the tool are designed to engage with the lifted object 4, 15. The tong 1 and tong tip 1′ may comprise of a single or multiple tong components and materials. Tong 1 +tong tip 1′ and components may be securely fastened together such that the tong assembly 14 acts as one piece to include the sliding friction-lock pivot 9. The contact point 8 of the tongs 1, and tong tips 1′ to the lifted object 4, 15 should be designed in a way to provide optimal engagement and grip to the lifted object 4, 15. When possible a prying action is also applied to the lifted object 4, 15 against its surroundings from contact point 18. One embodiment of this design is optimized to engage on utility curb valve cover lids such that when the operator applies a lifting force 5 to the handle 3 the tongs 1 and tong tips 1′ rotate to sweep under the top lip of the valve cover to provide positive engagement with the lid. This positive engagement is the difference between the locked engagement distance 11 and unlocked engagement distance 13. Other embodiment's may include increased friction pads or other specific tong end 1′ shapes required by the lifted object at the contact point 8.

In one embodiment the sliding friction-lock pivot 9 comprises the area between tong 1 and tong tip 1′ and surrounds the locking arm 2. The sliding friction-lock pivot may be integrated into the tong 1, located between tong 1 and tong tip 1′, or act in conjunction with the tong 1 and tong tip 1′ assembly. The action of the sliding friction-lock pivots 9 allow for the unrestricted motion of the two symmetric halves of the carrier tool against each other when the tongs 1 are below their critical angle 17 thus allowing for the tool to be adjusted to the lifted objects 4, 15 particular size. This unrestricted motion is provided by the clearance fit 12 or complete absence of material in contact with the idle arms 2 during carrier tool placement. When the tongs 1 are rotated through a lifting force 5 applied to the handle 3 the sliding friction-lock pivot 9 will allow for rotation and additional clamping of the carrier tool to the lifted object 4, 15 until the critical angle 17 is reached and the sliding friction-lock pivot frictional contact points 10 contact the locking arms 2. At this point their can no longer be any relative motion between the components of the carrier tool and it is effectively locked onto the lifted object 4, 15. An additional action of the sliding friction-lock pivots 9 is to allow for a compression force to be generated between the tong tips 1′ to the lifted object 4, 15 to aid in gripping. In practice, lifting force 5 will never be applied directly over the center of the carrier tool this forces one of the two sliding friction-lock pivots 9 to always engage and lock before the other. With any one sliding friction-lock pivot 9 engaged, the carrier tool can no longer adjust in size long the locking arms 2. At this point any further rotation of the unlocked tong 1 by lifting force 5 will generate compression force between the object contact points 8 of the tong tips 1′ rotating against the locking arm pivot 7 allowing for secure gripping of the lifted object 4, 15. The material of the sliding friction-lock pivot contact points 10 should be suitable for repeated compression and abrasion resistance against the locking arms 2 such as 4140, tool steel, or similar. It is advisable that the hardness of the sliding friction-lock pivot contact points 10 should be greater than that of the locking arms 2 to ensure long term reliability.

The locking arms 2 are attached to the tongs 1 by the locking arm pivots 7. The location 16 of the locking arm pivot 7 relative to the contact point 8 determines the mechanical advantage that the tong 1 shall apply to the lifted object 4,15 in compression between the tongs tips 1′. The closer the locking arm pivot 7 is to the object contact point 8 the greater the compression force generated and smaller the locked engagement distance 11 for the same lifting force 5 applied to the carrier tool handle 3. The locking arms 2 are manufactured of a material suitable for repeated compression and wear resistance against the sliding friction-locks pivot contact points 10 such as 4140 or similar. The surface hardness of the locking arms 2 should be less than that of the friction-lock contact points 10 to ensure long term reliability.

The locked engagement distance 11 of the tong tip 1′ to the lifted object 4, 15 is a product of the tong tip 1′ and object contact point 8 geometry but will always be greater than the unlocked engagement distance 13. This allows for a secure grip of the lifted object 4, 15 by the carrier tool.

1. The invention claimed is a carrier tool comprising of:
operably arranged tongs that include a sliding friction-lock pivot which acts on a retention member pivotally attached to another tong;
a means to bias the tongs to contact the object to be carried;
and an actuating means to rotate the tong about its sliding friction-lock pivot to the point of friction-lock.

2. The tool set forth in claim 1 comprised of two symmetric tongs and retention members arranged in planar opposing fashion.

3. The tool set fourth in claim 1 utilizing a material of adequate stiffness to simultaneously act as a means to bias the tongs to contact the object to be carried and act as the actuating means for the tool.

4. The tool set forth in claim 1 with optimized tongs to provide a prying action upon objects against its surroundings while the tongs are rotated through the range of motion provided by the sliding friction-lock.

5. In accordance with claim 1 the tool is used to lift utility valve covers through insertion of the tongs into two spaced holes or pick-points.
